(19) United States
(12) Patent Application Publication
(10) Pub. No.: US 2017/0092153 A1
(43) Pub. Date: Mar. 30, 2017

(54) Assistive Grid For Mobile Devices

(71) Applicant: Mark Horbal, Boca Raton, FL (US)

(72) Inventor: Mark Horbal, Boca Raton, FL (US)

(21) Appl. No.: 14/871,019

(22) Filed: Sep. 30, 2015

(51) Int. Cl. G09B 21/00; G06F 1/16; G06F 3/041

(52) U.S. Cl. CPC G09B 21/003; G06F 3/0412; G06F 3/0416; G06F 1/1643; G06F 1/1698

(57) ABSTRACT

An assistive grid that overlays the touch screen of a device such as a smart phone, tablet computer, or other intelligent device that allows blind or otherwise visually impaired users to easily locate and touch standard locations on the device's touch panel screen. A standardized user interface is presented by applications on the device, or on Internet websites accessed by the device, provides a standardized method of interacting with a multitude of applications and websites by the visually impaired or blind. Gestures that enhance usability of the interface by the blind are provided. Optionally, the assistive grid can incorporate raised indicia, such as Braille, on the grid surface to aid a blind user when learning how to use a given device.

### BACKGROUND

Technical Field

This invention relates in general to portable electronic devices for the visually impaired. In particular, it relates to a novel case for mobile smart devices, such as cellular phones, smart phones, computer tablets, and other portable electronic devices that use touch panel displays. The invention provides an external Assistive Grid (“Grid”) that allow visually impaired individuals to feel the location of keys or other input locations that are displayed on the device's touch panel that they would otherwise not be able to locate on a flat touch panel display. The invention discloses embodiments for mobile phones, tablets, and other smart Devices that employ a physical grid that facilitates enhanced usage of the device by visually impaired persons. The invention further teaches a method for standardizing application programs (“Apps”) executing on the devices as well as on websites accessed by the devices to present a user interface that properly interacts with the assistive grid.

Background of the Invention

Portable devices are ubiquitous in today's society. “Smart” mobile cell phones available today are becoming pervasive and are progressively replacing the older phones. In addition to smart cell phones there are many portable intelligent devices, such as tablet computers and portable terminals that have most or even all of the features of the smart telephones, such as GPS, access to Internet, ability to access websites and other remote servers and applications. For ease of discussion, smart cell phones, tablets and like devices will be referred to as “Devices”. Likewise, the term “Blind” will be used to refer to both legally blind and visually impaired individuals.

In recent times, mobile device covers or cases have been designed to contain additional batteries. Such covers or cases also include a connector that mates with the mobile device when such cover or case is used. Also, there exist a number of devices, which when mated with the mobile device via its digital interface or its audio input. An example of the latter is a magnetic credit card readers used for credit card authorization and payment via the mobile device.

Today, Devices have sufficient processing strength to support many useful features, such GPS location support, Internet access, telephony, audio output, voice input, voice recognition, and numerous software applications. Unfortunately, current Devices present a significant disadvantage to the Blind. In particular, portable Devices typically use touch panel displays without any mechanical data entry buttons or keyboards. Instead, they display icons on the touch panel display that represent the various functions provided by the Device. Of course, the Blind will find this type of input system very difficult, if not impossible, to use.

Today's Devices can be equipped with many applications and/or access to websites and external services that are potentially extremely useful to Blind individuals. Because of their inherent complexity, modern Devices typically employ a touch screen as the primary interface between the user and the device. The touch screen interface is used (a) to select and initiate the operation of an App resident on the Device or on a remote website, (b) to interact with the said App or Website, and (c) to configure and control the device itself. A traditional touch screen paradigm involves the use of a number of different context-sensitive screens. For example, in its normal (rest) state, the device typically displays a menu of available Apps and/or websites and allows an app to be started or a webpage to be displayed. In some cases, these Apps or web pages have been accessed earlier and the menu simply switches the context to the previously started App or previously accessed web page. Once the context is switched to the App or web page, the touch screen interface is used to interact with the App or web page in order to perform the desired functions. The interface can also be used to return to the main menu or switch to another App or web page.

Although intuitive and easy to use for most people, the touch screen user interface is very challenging for the Blind for a number of reasons: (a) the App/Web elements are typically displayed as icons that cannot be seen by the Blind, (b) physical interaction with the touch screen is accomplished by a precise visually guided touch by the user, a task impossible for the Blind, (c) even if learned, the position of screen icons can change by reconfiguration or updates to the Apps or the operating system of the device, and (d) although the Devices themselves typically adhere to a consistent positioning of icons used to start/enter Apps and web pages from the menu, these standards are typically not followed by the Apps or web pages themselves, once started or entered. Furthermore, even if a Blind person wants to use a simple application, such as making a telephone call, it can be difficult even if the keys are located in the same place. In addition, since Device touch screen sizes can vary from one model to another, migration to a new Device may require practice and learning by the Blind before the key locations for a simple phone call are learned. Of course, most Apps have icons that are not fixed like a telephone keypad, and as a result, they may not be usable by the Blind. As a result, while many useful Devices are taken for granted by the sighted, often cannot be used by the Blind. It would be desirable to have Devices that the Blind can conveniently control such that they can take advantage of the many useful features that the Devices offer.

While the prior art has provided a variety of high function Devices for the sighted, it has failed to provide Devices that can also be used by the Blind. It would be desirable to extend the features and advantages of these Devices to the Blind.

### SUMMARY OF THE INVENTION

This invention provides a Grid that is overlaid onto the touch screen of the Device in a manner that allows Blind users to easily locate and touch standard locations on the device screen. The invention further teaches a method for standardizing the user interface presented by Apps running on the Device or Internet website and web pages accessed by the device in order to provide a standardized method of interacting with the device by a Blind user that is both intuitive, easy to learn and use, and conceptually portable across a multitude of Apps and websites. Finally, the invention teaches a number of “Gestures” that enhance the use of the interface by the Blind. Gestures are methods employed in physically interacting with the touch screen and normally employed by the Devices. Common gestures employed by users to interact with device touch screens include tap, swipe, pinch, scroll, rotate and many others. The gestures taught by this invention are inherently simpler and intended for the blind user. Optionally, the Grid can incorporate raised indicia, such as Braille, on the Grid surface to aid a Blind user when learning how to use a given Device.

### BRIEF DESCRIPTION OF THE DRAWINGS

FIG. 1 illustrates a prior art cell phone encased in a prior art protective cover.

FIG. 2 illustrates a front view of a preferred embodiment of the assistive grid.

FIG. 3 illustrates a front view of a preferred embodiment of the invention that has optional Braille markings to assist a blind individual when learning to use, and then using, the assistive grid.

FIG. 4 illustrates the timing used by the gesture function.

### DETAILED DESCRIPTION OF THE PREFERRED EMBODIMENT

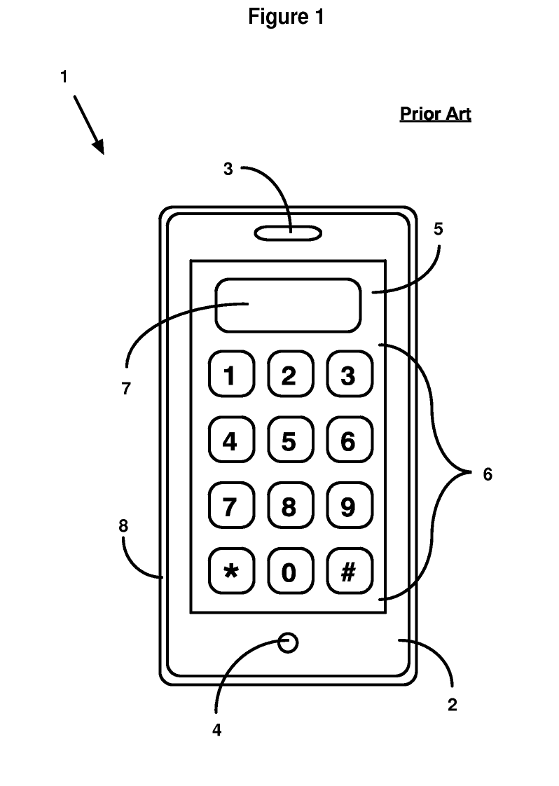

FIG. 1 illustrates a prior art cell phone 1 encased in a prior art protective cover 8. While a cell phone is used for illustrative purposes, those skilled in the art will recognize that the same configuration can be used for any number of intelligent portable devices 1, such as tablet computers (e.g. iPad™, iPod™, Microsoft Surface™ tablet, etc.), portable terminals, etc. Modern cell phones, especially smart phones, typically do no have mechanical keypads for data entry. Instead, flat touch panel displays have become the norm. Likewise, for ease of discussion, the invention is discussed in terms of a protective cover 8, but those skilled in the art will recognize that the grid 9 does not have to be integrated with a protective cover, and can be implemented solely as a grid 9 that defines the locations of data entry locations on a touch screen.

The prior art cell phone 1 that is used as an example in this figure typically has a body 2 that contains a speaker 3, a microphone 4, and a display panel 5. The display panel 5 is a touch panel display that allows a user to enter data for any application the smart device is used for. Typically, applications used by intelligent devices may change the information and/or icons displayed on the display panel 5. Even simple application, such as voice telephone calls, many devices have variations in the size and location of the telephone keypad from one model to another due to screen size.

Also shown in this figure are the informational display section 7 of the display panel 5 which typically would display information such as the number being dialed for outgoing calls, the caller ID of incoming calls, text messages, etc. While not a standard component of a typical device, many individuals use add-on protective covers 8. The protective cover 8 provides an improved gripping surface, as well as some impact protection in the event the device is inadvertently dropped.

While prior art devices, such as the one discussed above, provide great convenience and usability to sighted individuals, they also present substantial obstacles to the blind. Due to the flat, smooth nature of touch panel displays, a blind individual can never be certain that they have touched the display panel 5 at the proper location. As a result, incorrect phone numbers can be dialed, incorrect application data selections cane be made, etc. If an individual uses a new device, the location of the data entry points (keys) on the display panel 5 may not be the same. Likewise, as cell phone screen sizes change, the size and location of the keys will change. All of these factors have little effect on the sighted, but have very substantial effects on the blind.

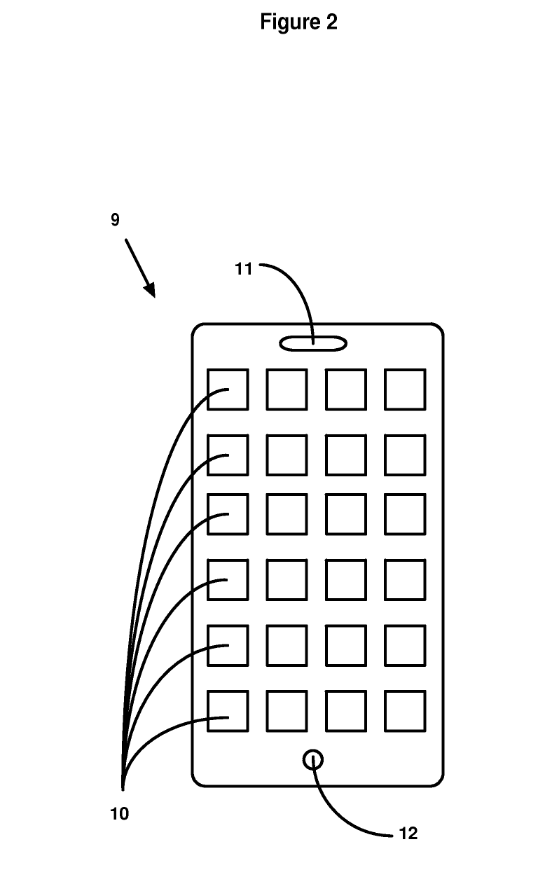

FIG. 2 illustrates a front view of the front surface of a preferred embodiment of the assistive grid 9. The grid 9 has a speaker aperture 11 that overlays the speaker 3, and a microphone aperture that overlays the microphone 4. A preselected number of icon apertures 10 are located on the grid 9 and are positioned to allow access to icons displayed on the display panel 5. When attached to a device 1, the icon apertures 10 allow a blind individual to know precisely where the input locations are on the display panel 5. As a result, the blind individual can make phone calls to the correct number, or can select other applications without making errors. In addition, the grid 9 helps in a) selecting the correct device-resident apps or external websites, b) correctly interacting with such device-resident apps or external websites, and c) interacting with the device itself, in order to change settings, etc.

The assistive grid 9 has multiple embodiments, because it can be used with a variety of devices that each having their own shape, size, and configuration. For example, the grid 9 can be configured as a snap-on case into which the device is placed such that the grid 9 is positioned and aligned with the device's display panel 5. It can be configured as part of a case that covers the entire device. It can be configured as grid 9 that is secured to the display panel 5 with and adhesive that secures it to the device via double stick tape, adhesive, etc. Likewise, the grid 9 can be hinged to the device case. Any suitable means of attachment of the grid 9 to the device can be used, including adhesives, magnets, and fasteners such as screws or those in which the grid 9 is an integral component of the device itself. If the grid 9 is fabricated from flexible material such as rubberized material, it can easily be secured the device by sliding the device into the grid 9. In this configuration, the grid 9 provides an additional advantage by providing protection against damage that may occur if the device is inadvertently impacted.

The grid 9 is preferably equipped with number of icon apertures 10 in standard locations and with standard spacing corresponding to the position of active touch areas on the display panel 5 that are used to activate applications resident on the device and/or to interact with remote applications on the Internet or other remote systems. The icon apertures 10 can define the location of input areas for telephone functions (e.g., the keypad, and caller ID display, etc.), and also for other icon locations that are used to select any one of a variety of applications.

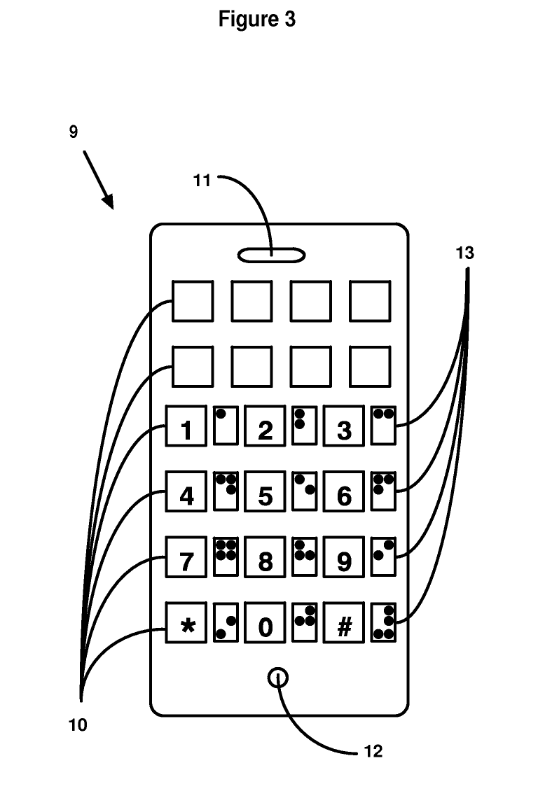

FIG. 3 illustrates a front view of a preferred embodiment of the invention that has optional Braille symbols 13 and/or possibly other symbols to assist a blind individual when learning to use the assistive grid 9. Those skilled in the art will recognize that the Braille symbols 13 can vary in size and be located in any convenient location near their associated icon apertures 10. This figure shows the grid 9 mounted on a device such that the icon apertures 10 expose the icons displayed on the device's display panel 5. In this case, the icons represent the numbers on a telephone keypad. Adjacent each icon is the Braille symbol 13 that represents the keypad number. Having the convenience of the Braille symbol is a useful aid for blind individuals who are just learning how to use the device. In addition, the Braille markings can continue to be useful even after the user is familiar with the grid 9.

Of course, proper alignment of the grid 9 with the device is important for the invention to work properly. One preferred method of alignment is to mold the grid 9 in the form of a sleeve, fabricated from any suitable pliant rubber-like material, into which the device is inserted. This allows the device to automatically align with the icons on the display panel 5 and simultaneously provides a protective cover for the device. However, since there are numerous other applications in addition to the basic telephone function, the arrangement of icons can vary from one application to another. In order for the grid to be used, there must exist a system of aligning the position and size of the icons displayed on the device's screen to the position and size of the grid apertures. While current devices, such as mobile phones, already provide a somewhat standardized icon layout, the layouts cannot be considered as sufficiently standardized to always work reliably with grid. In order to ensure correct alignment, the device should provide a means of configuring its display in order to ensure alignment of the displayed icons with the geometry of the grid 9.

While icons of built-in functions of a device are relatively easy to align, the alignment with the icons of the multitude of online applications is more difficult. Much of today's content is delivered to users via Internet websites. Once such websites are accessed via the device's browser, alignment can no longer be assured. Via standardization of website versions for the visually impaired. Although the W3 standard provides guidelines for improvement of accessibility to websites by handicapped individuals, the current standard is not sufficiently detailed to provide a comprehensive mechanism for interaction with handicapped individuals and especially those visually impaired. Therefore, this invention teaches means for accomplishing this, as follows:

Once the website is notified by the device that it is used by a browser used by the visually impaired, the alternative website provides alternative website pages for visually impaired individuals. The website uses:

Interactive Website Standardization.

Standardization of the placement and size of interaction points (buttons etc.) on such pages in a manner that is consistent with the geometry of the assistive grid 9, so that such pages can be used by the visually impaired.

Standardization Includes Geometry and Function.

Standardization includes consistency of placement of the web page's point of interaction (buttons, etc.) in consistent positions relative to the page itself and in relation to each other. For example, buttons with functions such as “Information About This Page”, “Help”, “Submit” etc. should be positioned to provide maximum portability of the handicapped user's learning curve from one application or web page to another.

Non-Interactive Website Standardization.

The Device's browser to be configured to send information to the website being accessed that describes the configuration of the particular assistive grid 9 being used so that the website can display its pages in a manner that is consistent with the geometry of the assistive grid 9. For example, the display panel sizes can vary widely from one manufacturer to another, and as a result, icon sizes and locations will vary. This requires that the device inform the website application, during initial engagement, of the particular device's configuration.

Browser/Client-Side Page HTML Rewriting.

The device's browser to be configured to “rewrite” the HTML delivered by the website so that the web page interaction points (buttons etc.) are displayed in positions consistent with the geometry of the assistive grid 9.

User Agent.

The User Agent information in the HTTP request header identifying the User's/Device's browser is extended to include the configuration of the assistive grid 9, or alternatively, the creation of an additional information field in the HTTP request for this purpose. Likewise, an extension to include a user's special needs is an additional information field that can be added in the HTTP request.

Audio Help.

Similar to the HTML button formation attribute, above, a new attribute is added to the button to provide a URL to an audio file containing help information that he user can play to explain the function and use of the button. A resident library of audio help files can also be provided to assist users having difficulty when learning the device.

Another feature if the invention is the use of Assistive Gestures in applications resident on the device as well as the device's browser. For example, a long tap (tap and hold) of the button through an aperture of the can simply provide audio help (see Audio Help above). Likewise, a short tap actually performs the corresponding action or causes a submit action if in the browser. The combination of these two gestures is both helpful and intuitive to a visually impaired user. If the button is initially held down for a longer period, after which the audio help is provided. Subsequently, a short tap in the same place actually performs the action, if desired. Else, the gestures can be performed using a different button, until the correct one is located.

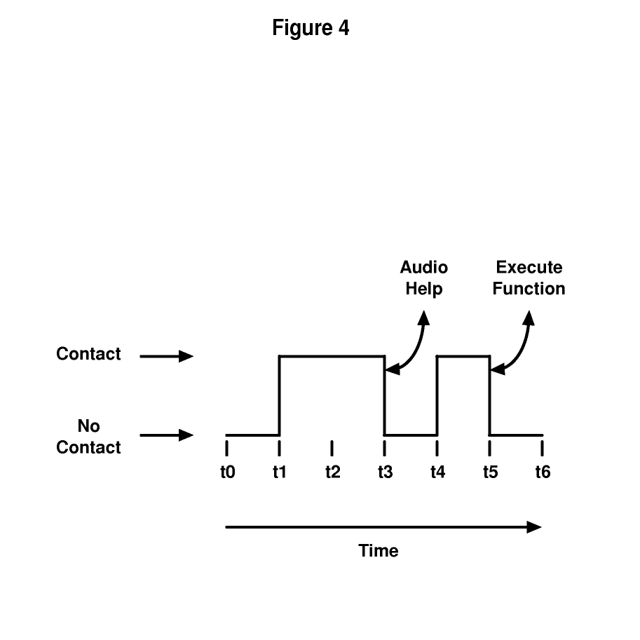

FIG. 4 illustrates how a gesture works. At time to, the user is not making contact with the display panel 5, and the device is at rest. At time t1, the user contacts touch panel 5 and maintains contact until time t3. At initial contact at t1, the device begins measuring the length of the contact. When the device determines that the contact has been maintained for an extended period, until time t3, the device determines that a request for help is being made. As a result, at time t3, the device activates either an internal audio help process, or an external request for audio help from an Internet URL. On the other hand, if help is not needed, then the user merely taps on the display panel 5 rather than maintaining contact. This is shown at time t4, where the user only maintains contact through time t5. The device determines, based on the short contact, that there is a request to execute the selected function.

The invention provides a number of benefits. The assistive grid 9, which is physically overlaid over the touch screen of mobile devices, such as mobile phones, has a plurality of aperture positions and sizes to further assist in interaction by individuals with various levels of visual handicaps. Depending on the device and application being used, the grid geometry can vary. For example, it could have icon apertures 10 arranged in 6 rows×4 columns, 4 rows×3 columns or a different configuration. The correct icon layout on the device's touch panel 5 can be assured by appropriately configuring the device via its settings, reflecting different grid aperture configurations, and also communicating those settings to the application on the website URL that is being used. Communication with the remote website allows the website to know the configuration of the device and the assistive grid so that adjustments can be made to icon locations, etc. While external websites can be programmed to take advantage of the invention, local device resident applications can also be programmed to take advantage of the invention. Optional Braille indicia also aid the blind while leaning how to use the grid 9.

The invention also allows users to take advantage of additional technology, such as RFID and/or near field communications (“NEC”). NFC tags can be used to provide inexpensive access to very local information. For purposes of discussion, the term NFC (Near Field Communication) will be used to mean NFC or RFID (Radio Frequency Identification). While this invention's primary focus is on passive RFID or NFC tags, active tags can be used as well to increase range, although such increased range is not always useful.

A passive tag is an electronic device that is able to transmit its ID when energized by an external radio wave field. Usually, such field is provided by the reader, which both powers the passive tag by transmitting a radio wave field and then receives the ID transmitted by the tag. Once the powering field is removed, the tag loses power and deactivates.

By way of example, a passive RFID/NFC tag is attached to a physical location, in this case, a bus stop post. The tag is packaged such that a person can recognize it visually, or by touch. For ease of discussion, the term “geotag” will be used.

A geotag consists of a i) passive or active NFC or RFID tag containing a unique ID, ii) encapsulated in a case or package and iii) equipped with a means of attaching the geotag to a building structure such as a door, the interior of an elevator, exterior of a vending machine, a bust stop post and others.

The shape and external appearance of a geotag is important in that it allows the device to be visually recognized by normal people and recognized by palpation by those who are blind or visually handicapped.

The locations and position at which geotags are mounted should adhere to a standard, so they may be easily located. For example, building floors are typically printed or otherwise indicated on the frame of the elevator doors, the position of Braille markings for elevator buttons is standardized etc. There are many other examples, such as the street crossing warnings using truncated spheres (“warning dots”) at intersections, in order to facilitate pedestrian safety for the blind.

The means of attachment of a geotag to a building structure, post, vending machine or other structure can vary, depending on the properties of the structure to which the geotag is attached. For example, the means of attachment can be an appropriate adhesive; an eye through which a screw fastener is passed, a clamp, such as may be used to attach the geotag to a post, etc.

Preferably, a particular geotag corresponds to a particular website or a particular page of a particular website, so that when a geotag is read by a mobile device, such as a mobile telephone or tablet, the user's mobile device browser is directed to that website or a particular web page of that website, and that website or that page of the website that provides the desired local information.

One possible embodiment of a geotag is a conspicuously shaped plastic or epoxy object with a mechanically embedded and thus environmentally sealed RFID/NFC tag and a means of attachment, such as an adhesive pad, a fastener hole or a clamp. In general, the means of attachment is preferably simple and secure.

In a preferred embodiment, the operation of the system would include the following steps:

1. Each geotag is registered with a central authority or “registry” once mounted to a location. The process must be properly authenticated in order to prevent misuse of the device and its associated web page. As described further, the registration process can additionally include the GPS coordinates of the location at which the geotag is mounted, in order to improve the security of its subsequent use.

2. The mobile device activates the geotag with an electromagnetic field. This occurs when the mobile device is brought into close proximity with the passive geotag. This step is unnecessary if the geotag is active, being powered by an external source, in which case proximity between the geotag and the mobile device is unnecessary.

3. The geotag transmits its ID to the mobile application.

4. The mobile application makes a request to the registry service.

5. The registry service returning the website or webpage URL (Uniform Resource Locator) corresponding to the geotag's id, as provided in the registration process.

6. The URL is provided to the mobile device's browser which than accesses the website or webpage as provided by the registry service.

7. The local information corresponding to the geotag is provided to the device's browser.

8. If the interaction with the website or web page involves interaction with a device or system such as an elevator, traffic light, metro transportation system, etc., then the accessed website or webpage interactively communicates with such device or system.

A person activates the geotag with his mobile device (e.g. a phone equipped with an integral NFC reader or an externally connected NFC reader device, causing the geotag to be powered). This allows the mobile device to receive the geotag's id. This id can now be used by the software contained in the mobile device to access a website, via the mobile device's resident browser, that corresponds to this particular bus stop. The website, in turn, can now provide the user local information corresponding to this particular bus stop—for example, the route numbers which stop at this bus stop, the time of arrival of the next bus and its route number, etc.

The above example summarizes the essence of this embodiment. Important elements include: a) Passive, and in some cases active, RFID/NFC geotags permanently attached to physical locations; b) A mobile device capable of reading RFID/NFC geotags and having a browser capable of accessing websites providing local information corresponding to the particular geotag, and; c) A system of translating the geotag's id into an address of a website that provides the above local information to the user.

In the foregoing example, “local information” is limited in scope and is highly relevant to a location within a very limited radius of a specific location. Examples of such “locations” and the associated “local information” are:

1. Static information, such as a buildings address, or
2. Dynamic information, such as time of day, next bus number scheduled to arrive, the current floor an elevator is on, etc., or
3. Interactive information, for example, user interaction with a website corresponding to a particular bus stop to notify the driver that that the bus should stop at a particular location

The table below offers a number of examples of local information and its types:

| Location | Local Information |
|---|---|
| Office | Building directory (static or dynamic) |
| building | Emergency locations and services (static) |
| entry | Alert (e.g. ring doorbell of) a selected tenant. |
| Elevator | Which floors the elevator services (static) |
| | Current elevator location/direction e.g. 12th |
| | floor/UP (dynamic) |
| | User enters floor number (interactive) |
| Museum | Description of displayed object (static) |
| | Narrative (static) |
| Vending | Items vended and respective prices (static) |
| machine | User places order (interactive) |
| | Mobile Payment (interactive) |
| Bus Stop | Route information (static) |
| | Approximate wait time (dynamic) |
| | Payment capability (interactive) |
| On public | Bus/train/line description (static or dynamic) |
| transportation | Destination/direction (dynamic) |
| | Next stop (dynamic) |
| | Payment capability (interactive) |
| Street signs | Location (static) |
| Traffic light | Location (static) |
| signs | Light state, time to yellow or “Don't Walk” (dynamic) |
| | Request to cross (interactive) |
| | Remaining duration of green/safe light (dynamic) |
| | Request for assistance |
| Parking Meter | Remaining time for payer (static) |
| | Payment (interactive) |
| Automatic | Check balance (dynamic) |
| Teller | Login, Retrieve cash, Transfer funds between |
| Machine | accounts (interactive) |
| Diagnostic | Car/device/etc. status, error codes (dynamic) |
| port in car, | Access to instruction, service manuals (static) |
| appliance, | Changing device settings (interactive) |
| etc. | |

NFC and/or RFI technology provides several advantages, including:

1. Providing a convenient means of rapidly gaining access to local information. For example, the convenience of interacting with a geotag-equipped bus stop or tapping a geotag to hear a narrative about a particular exhibit in a museum

2. Allowing devices, such as appliances, parking meters, etc. to have an equivalent of a user interface, without increasing the cost of the device with the cost of a user interface, which frequently involves displays, pushbuttons etc., especially if the device needs to be weatherproof.

3. In addition, the cost of a geotag is exceptionally low. In quantities, RFID/NFC tags can be added to any number of devices at a very nominal cost per device.

4. Geotags are especially valuable to those who are blind or visually handicapped. Geotags can be easily deployed in building interiors or exteriors, elevators, street crossing, public transportation stops, on vending machines and in a vast number of other locations where local information is needed but not generally available to the visually handicapped.

Consider the benefit of installing geotags in each of an office building's elevators, allowing the blind to use their mobile devices to select their destination floor and to know when they arrive there. Consider also, the benefit of installing geotags on buses, in order to allow blind people not only to confirm that they are boarding the correct bus, to select their destination stop, track the bus' progress and be informed when they arrive to their destination. Further, geotag-based mapping of interior spaces, allows blind users to determine their location in a building, geotag-equipped vending and automatic teller machines and many devices allow blind users to effectively use those devices.

The preferred embodiment of the invention provides for a level of security to prevent misuse of the invention, such as (i) relocation of the geotag to a different location after it's location and function has been registered with the registry service, (ii) interjection of a false registry service that can provide incorrect website or webpage information to the requesting mobile device, or (iii) tampering with the geotag itself.

To address these security concerns, the invention provides the following security mechanisms:

1. Upon the installation of each new geotag, it's ID and the corresponding website or web page information must be registered with a registry service in order for the latter to service ID lookup requests. During this same process, the geotag's GPS coordinates are registered as well. Subsequently, in normal operation occurring thereafter, upon reading the geotag's id, the mobile application sends the id along with the GPS coordinates of the mobile device itself, as provided by the mobile device's GPS mechanism, to the registry service. Upon receiving the request from the mobile device, the registry compares the provided GPS coordinates with the coordinates of the geotag, as stored in it's database, validating the request if such coordinates are within a reasonable and expected distance of each other. Otherwise, an appropriate error is returned to the requesting device.

2. The registry is configured with an SSL (Secure Sockets Layer) or TLS (Transport Layer Security) certificate that authenticates the registry service to the requesting mobile device application, similarly to a bank website SSL/TLS certificate verifying its authenticity. In addition, the presence of the SSL/TLS certificate on the registry service website allows the request/response communication between the mobile app and the registry service to be encrypted, preventing man-in-the-middle attacks. The security measures described here also protect the initial geotag registration process.

3. The geotag can also include a means for rendering it inoperative when removed after the initial installation or when tampered with. This security feature, if used, prevents misuse of the device.

Another alternative embodiment of the invention additionally discloses “announcement” geotags. The operation of these is similar to that of other geotags except that these are externally powered and thus transmit their ID continuously, thus not requiring proximity to the mobile device. Once such id is received by the mobile app the registry service is queried and the device's browser access the website in the usual way, allowing the associated website to stream an audio announcement message such as “You are now on track 6. Train 475 bound for Geneva leaves at 3 PM” or “This elevator services floors 1 through 20”.

While generally useful to the overall population, this invention is especially helpful to those who are blind or visually handicapped. In order for such usefulness to be maximized, the website or web pages accessed via the mechanism described herein must provide audio information and display/position their interactive buttons in a well organized and ideally standardized way, in order to maximize their usability by the blind.

While specific embodiments have been discussed to illustrate the invention, it will be understood by those skilled in the art that variations in the embodiments can be made without departing from the spirit of the invention. The types of materials used can vary, the method of attachment can vary, etc. Therefore, the invention shall be limited solely to the scope of the claims.

I claim:

1. A grid for attachment to an electronic device having a touch panel display, comprising:
a plurality of apertures in the grid that define data entry or display locations on a touch panel display; and
the grid is sized and the apertures are arranged to fit selected electronic devices.

2. A grid, as in claim 1, wherein:
at least one aperture in the grid defines a data entry point; and
at least one aperture in the grid defines a display area.

3. A grid, as in claim 1, further comprising at least one Braille indicia adjacent to at least one of the plurality of apertures.

4. A grid, as in claim 1, wherein
the grid is incorporated into a protective cover that attaches to the electronic device; and
the grid is sized to attach to a cell phone, a smart phone, a tablet computer, a laptop computer, a notebook computer, or a special purpose electronic device.

5. A grid, as in claim 1, wherein the grid is sized to attach to a cell phone, a smart phone, a tablet computer, a laptop computer, a notebook computer, or a special purpose electronic device.

6. A grid system for an electronic device, further comprising:
an electronic device having a touch panel display; and
a grid having a plurality of apertures that define data entry or display locations on a touch panel display.

7. A system, as in claim 6, further comprising at least one Braille indicia adjacent to at least one of the plurality of apertures.

8. A system, as in claim 6, further comprising:
a time-based activation function that is activated by amount of time that the data entry location is contacted by the user; and
at least one internal application in the electronic device that is activated by the time-based activation function.

9. A system, as in claim 8, wherein:
at least one external application in a remote system that communicates with the electronic device in response to the time-based activation function.

10. A system, as in claim 6, wherein a plurality of grids are used for a plurality of corresponding applications in the electronic device.

11. A system, as in claim 6, wherein the grids are disposable.

12. A system, as in claim 6, further comprising:
a transceiver in the electronic device for communicating with remote systems using Internet HTTP protocols having an HTTP request header;
a browser in the electronic device; and
an extension in the request header that includes an extension that contains user agent information that identifies the browser and device information that describes the configuration of the grid;
whereby a remote system is provided information related to the device's grid configuration.

13. A system, as in claim 12, further comprising:
a remote website, operatively connected to the Internet and having software for interpreting the user agent information such that data returned to the system is formatted to correctly display on the touch panel display.
whereby a remote website uses the user agent information to format data transmitted to the system to conform to the device's grid configuration.

14. A system, as in claim 13, wherein:
the grid has a standardized format for placement of input locations for points of interaction on the touch panel display; and
the user agent information includes data describing the location of points of interaction on the touch panel display such that remote websites having one or more applications configure responses to the system that conform to the standardized format;
whereby remote websites configure their data to conform to the standardized format such that a visually impaired individual knows where specific function inputs are located on the touch panel display.

15. A system, as in claim 14, wherein:
the remote website inputs and interprets the user agent information; and
responses to the system are configured by the remote system such that data displayed on the touch panel display and the location of the points of interaction on the touch panel display are configured by the remote system based on the user agent information.

16. A system, as in claim 14, wherein:
the system receives data from the remote website and compares that data to the location of the points of interaction in the user agent information; and
the system reconfigures remote website data displayed on the touch panel display such that the location of the points of interaction on the touch panel display conform to the user agent information.

17. A protective cover for an electronic device having a touch panel display, comprising:
a protective cover that encloses an electronic device;
a grid in the surface of the protective cover that is positioned above the touch panel display;
plurality of apertures in the grid that define data entry or display locations on a touch panel display;
the grid is sized and the apertures are arranged to fit selected electronic devices;
the grid further.

18. A protective cover, as in claim 17, wherein:
the grid is removably attachable to the protective cover.

19. A protective cover, as in claim 18, further comprising at least one Braille indicia adjacent to at least one of the plurality of apertures.

20. A protective cover, as in claim 17, further comprising at least one Braille indicia adjacent to at least one of the plurality of apertures.
